(19) United States
(12) Patent Application Publication
(10) Pub. No.: US 2009/0136902 A1
(43) Pub. Date: May 28, 2009

(54) BLANK AS A DRILLING TEMPLATE AND FOR RECORDING DATA SETS

(76) Inventors: Gerhard Zundorf, Bonn (DE); Erwin Keeve, Bonn (DE); Lutz Ritter, Bornheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/064,720

(22) PCT Filed: Aug. 25, 2006
(86) PCT No.: PCT/EP2006/008364

§ 371 Date: Aug. 20, 2008

(30) Foreign Application Priority Data
Aug. 26, 2005 (DE) 10 2005 040 738.2
Aug. 26, 2005 (DE) 10 2005 040 739.0

(51) Int. Cl. A61C 13/08

(52) U.S. Cl. 433/223; 433/202.1

(57) ABSTRACT

Process for defining a common reference system between, on the one hand, a set of image data, which show the jaw (6) of a patient and which are recorded with an imaging process, and, on the other hand, a treatment template, which is attached in a removable manner during an operational intervention to the teeth of the patient in a defined position and which has a structure that is used to guide an instrument, whereby markers are provided on the treatment template that can be detected by means of the imaging process and that form a reference system, whereby a template blank (13) that is provided with markers (16) is attached to the patient at the site to be treated by means of a hardening impression material (19) on at least one tooth and/or the jaw, whereby the set of image data with the template blank that is used is recorded, whereby the template blank together with the hardened and in particular break-proof impression material is removed and is clamped in a processing device, and whereby the structure that is necessary for guiding is introduced by tools of the processing device into the template blank, whereby the tools are moved according to a plan carried out on the image data.

This invention relates to a process for defining a common reference system between, on the one hand, a set of image data, which show the jaw of a patient and which are recorded with an imaging process, such as CT, NMR or cone beam, and, on the other hand, a treatment template, which is attached in a removable manner during an operational intervention to the teeth of the patient in a defined position and which has a structure that is used to guide an instrument, whereby markers are provided on the treatment template that can be shown by means of the imaging process and that form a reference system. The invention relates, moreover, to a template blank for the production of a treatment template and an additional, especially advantageous use of the template blank.

From oral-surgical implantology, it is known to insert dental implants into a predrilled channel, which was introduced by means of a drilling template into the jaw of the patient. In this case, the production of the drilling template is carried out based on a model of the set of teeth, in particular on a plaster impression. In the later operation, as on the plaster impression, the drilling template can be mounted at the same position on the patient's teeth. With such a drilling template, the danger of inadvertent injury to the critical anatomical structure, which exists in hands-free drilling, is reduced. The expense for the production of the template is considerable, however. Thus, in most cases several days go by between the first seating, in which an x-ray recording and an impression are constructed, and the insertion of the implants. The reason for this lies in the fact that the attending dentist must work with the dentistry laboratory that produces the drilling template based on the plaster model.

From WO 2005/023138 A1, it is known to use tomographic volume data sets in the production of such drilling templates. In this case, within the framework of the planning, the drilling channel is simulated in its depth, its diameter and its orientation to the computer model and it is passed on with these parameters to the drilling template that later rests on a defined site on the teeth. To make possible the correct transfer to the drilling template, the position of the drilling template must correspond exactly in the volume data set, in the physical model and also relative to the jaw of the patient. The definition of a common reference system is achieved by means of a “recording,” in which WO 2005/023138 A1 proposes a small plate that is used as a marker for the template that is produced on the dental model.

According to this prior art, the template is constructed based on the plaster model by means of a deep-draw process, whereby a heated film is adapted to the plaster model by overpressure. The film is rigid after cooling and can be used as a template. All known processes for the production of a drilling template use the intermediate step with the plaster model.

The object of the invention is therefore first to create a process for recording a treatment template relative to a set of data recorded by volume-tomography, which can be made even directly by the attending physician in a simple way and by the most economical means. Moreover, a treatment template that uses a template blank is to be created, and said treatment template is to be simple and quick to produce and, in addition, comfortable to handle. In addition, the object of the invention is to propose an especially advantageous use of the template blank.

These objects are achieved by the process according to claim 1, the template blank according to claim 4, and the use of the same according to claim 10. Advantageous embodiments of the invention are mentioned in the respective subclaims.

A first essential idea of the invention is first to use a means to be used for recording directly as a template blank, from which the treatment template is produced in a process step that directly succeeds the recording of the patient data. According to the invention, such a template blank that is equipped with markers is mounted by means of a hardening impression material on a patient's tooth and/or jaw at the site to be treated before the set of image data of the jaw is recorded with the template blank that is used in a scan, in particular by means of CT, NMR or cone beam. The marks that are in the template blank define a reference system, which makes recording possible.

As markers, in general all defined “marking” structures of the template blank, such as corners and/or edges, are suitable. To obtain a more specific localization, it is advantageous, however, to provide the template blank with especially obvious and/or especially readily detectable structures that then are used as markers.

After the scan, the template blank together with the hardened impression material is removed and subsequently clamped in a processing device, whereby the impression material should not experience any damage. In the meantime, the planning of the treatment can be carried out on the patient data in the reference system formed by the markers of the template blank. In particular, within the framework of the planning, the location, the size, and the orientation of the drilled hole extending through the template blank are specified. In the processing device, the template blank is clamped in a defined position, such that the structure that is necessary for guiding the instruments, in particular the drilling, can be extracted from the template blank with a machine tool. To this end, the tools corresponding to the planning performed on the image data are moved by computer control in the system with the recorded reference system. Thus, a treatment template, which can be mounted at the correct position on the patient's teeth, is provided.

Advantageously, the template blank is configured as a small stable plate in such a way that it covers several teeth, including the tooth gaps that are to be filled with implants. The small plate according to the invention is coated with the impression material by the dentist before the scan and placed in the patient's tooth gap that is to be filled in such a way that the adjacent teeth provide an adequate grip. The small plates with the hardened impression material can be removed and exactly repositioned again at any time. After the scan and the processing, the template blank including the impression material is used as a treatment template, in particular as a drilling template. Advantageously, in this case for the process, a suitable impression material is used that can be easily processed after the hardening and that does not tend toward brittleness.

An essential standpoint of the invention is thus to use a stable template blank as a vehicle, which is tightly connected to an impression material, such that the forms from the template blank and impression material can be fed easily to a machining process, in particular drilling and/or grinding. To this end, the template blank must have an adequate thickness in the area of the tooth gaps to be able to give sufficient stability to the hole itself and/or to a drill sleeve used therein. The impression material accordingly is used essentially in the positioning on the jaw, while the positioning and stabilization of the hole or the drill sleeve is done by the template blank. The planning of the drilling channels to be introduced into the jaw is advantageously performed based on image-supported planning programs.

To ensure a sufficiently good grip of the impression material on the template blank, it is advantageous to provide structures on its bottom side that are buried in the impression material. These structures can be formed by, for example, ribs, which are distributed over the bottom side. In addition, it is advantageous if a drilling area with increased thickness is provided on the template blank, which makes possible a deep hole and thus a good guiding. The reinforced drilling area can be designed, to a certain extent, as an extension in the direction of the gum, which in taking impressions is oriented parallel to the surrounding dental axes. Such an extension is visible in the radiological image and, moreover, facilitates the planning.

Instead of the reinforced drilling area or else together with the reinforced drilling area, it may be advantageous in the drilling to use a drill sleeve that consists of a preferably biocompatible metal, for example titanium, in order to minimize the wear during the later drilling. To prevent artifacts during the scan, it is advantageous if the template blank consists of a sturdy plastic. In addition, it is advantageous to match the template blank to the anatomy of the respective jaw area, for example, by a curvature. For tooth gaps in various jaw regions, in particular for incisors and molars, template blanks that are matched to the anatomy can be provided.

The advantage of this invention lies in the fact that it is now possible for the dentist himself to produce a drilling template in a simple way in his office. The production of a plaster model is no longer necessary in this respect. An insertion of the implants can thus already be carried out a short time after the planning of the holes. The production of the drilling template thus takes place to a certain extent “live” and without a model. With the invention, it is possible for the dentist to provide reliable implants for individual teeth and inter-crown gaps and at a reduced cost by means of the drilling template according to the invention. Moreover, it is advantageous that the purchase of a dedicated drilling and grinding device does not take place, since already existing devices can be used because of the generally small working area. As an example of this, the Cerec System of the company Sirona Dental Systems GmbH can be mentioned, which is designed for the CAD/CAM-supported production of crowns.

With the invention, the safe drilling of holes in the jaw and thus the provision of good dental implants for the patients are ensured. The drilling holes are used in this case as a receiving bed for the implants, which in turn carry the false teeth. Since it is specifically in older patients that the bone available in the alveolar processes is reduced, the probability of the occurrence of complications, such as the penetration of the nerve canal or the paranasal sinuses with the drill, is increased. Therefore, the planning of the operation based on the radiological images and the use of drilling templates are of decisive advantage. Thus, it can be ensured that the planned drilling holes are transferred exactly into the jaw.

Another independent aspect of the invention is in the advantageous use of the template blank to be demonstrated below for purposes of recording. A recording in terms of an exact superimposing in the definition of a common reference system is always necessary if different sets of multidimensional image data, representing the same object, are to be compared to one another. In this case, a recording between three-dimensional image data from the patient's jaw, on the one hand, and a model of the jaw, on the other hand, can be performed with the template blank. Such a recording is necessary to relate to reality the treatment steps planned in the model.

To ensure this, a first type of marker that forms a reference system and that can be shown with the x-ray imaging process is provided on the template blank. Moreover, a second type of marker that is formed from optically detectable structures and that also forms a reference system is provided. Both reference systems are in close relationship with one another and are the same in the simplest case.

The idea of this portion of the invention is thus that the template blank that can be handled has the markers, on the one hand, which can be detected with the x-raying process, and that markers can be present, on the other hand, that can be detected with a purely optical process, for example with a laser scanner, in a surface data set of a model of the object. With these markers of different characteristics, the two data sets can be laid exactly over one another, whereby, on the one hand, for production reasons but primarily also because of the economizing on research operations, it is advantageous if the different characteristics are combined in each case in the same marker structure. According to the invention, a template blank, whose location in the space can be determined with computer support because of the attached and/or incorporated markers, is thus used to solve the recording problem. In this case, generally all defined “marking” structures of the template blank, such as corners or edges, are considered to be optically detectable markers. It is advantageous, however, to provide especially obvious structures that are used as markers.

With such a use of a thus equipped template blank, a device that can be handled to record these data sets is provided, which can be produced simply and economically and which, with simple handling that is suitable for practice, allows a specific recording of three-dimensional image data of an object, in particular image data of the jaw area of a patient, relative to data of a corresponding model.

The advantages of the use according to the invention of the template blank are in the especially simple mechanical design and in the simple handling. The preferred uses are the oral surgery, oral orthopedics and the corresponding prosthetics, respectively the implantology. Since the template blank is comparatively small as a device, its use by the patient is not felt to be uncomfortably strange. It is especially advantageous that the device, in an especially simple embodiment, rests only on the surface of a row of teeth and does not need to be clamped between the teeth. The template blank can be used by any attending physician without much practice. In this case, no special instructions are to be observed.

The type of recording that can be performed with the template blank offers a number of Advantages: Thus, on the one hand, the artifacts created by metals can be minimized in the volume data sets. This happens in that the surface data recorded by the model are accordingly combined by computer with the volume data, such that only the volume elements below the surface are shown. Thus, all data outside the jaw, in which artifacts particularly manifest themselves, are “calculated out” of the image, and thus the metal artifacts that adulterate the recording are minimized. By the superimposition of the data set with the artifact-free recording of the corresponding model, the outer contours of the patient data set with the same production of the relevant volume information can be correctly reproduced.

In the production of a surface data set, it may be that the image of the template blank masks interesting structures. To deal with this, it is advantageous to perform two optical scans, namely a first one to determine the position of the model in the image with the device and a second one without the template blank, in which the model has not moved relative to the recording device. The last recording is then superimposed on the patient scan.

Because of the simple design, it is especially advantageous if at least the optically detectable markers are designed as visible parts of a basic structure that is designed in particular as a small base plate and that corresponds to the device. This basic structure is advantageously to be dimensioned such that the dimensions are matched to a tooth or a row of a few teeth. The basic structure can be a small base plate, from one surface of which at least three markers protrude in a way that is visible from outside. The small base plate itself is advantageously made from a material of low density, in particular from plastic, and the x-rays are comparatively less absorbed. The small base plate is advantageously almost invisible to x-rays. However, the markers are to absorb the x-rays, so that they can be identified exactly in the image data. In this respect, they contain a material of higher density, in particular a ceramic or a metal of relatively low density, which does not form any of the above-mentioned artifacts.

Below, the invention is explained in more detail based on FIGS. 1 to 4. Here:

FIG. 1 shows individual process steps a)-d) with a template blank,

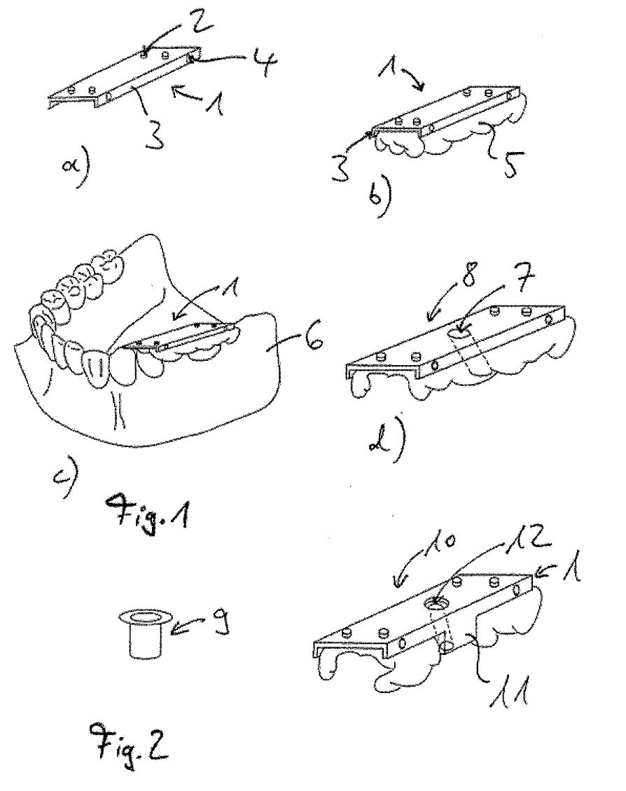

FIG. 2 shows a drilling template with a drill sleeve and drilling area,

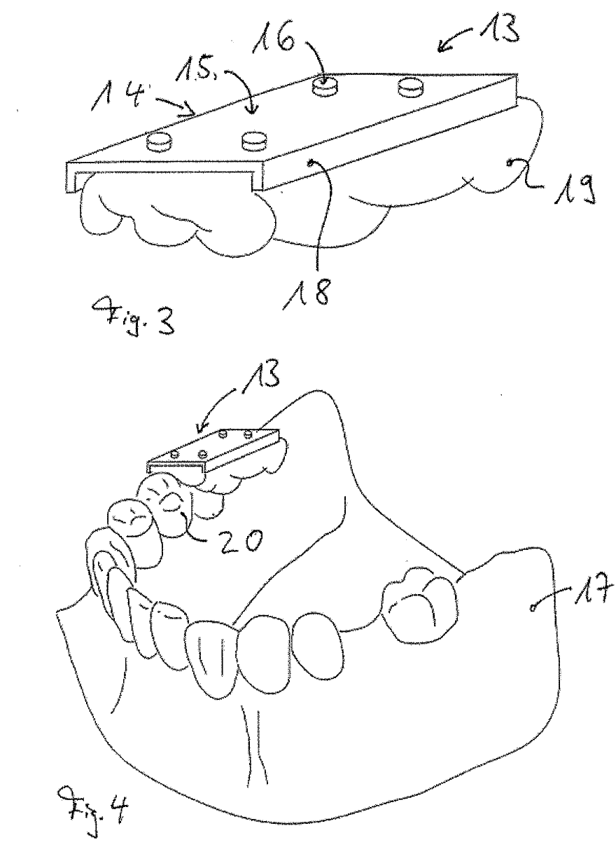

FIG. 3 shows a template blank for recording and

FIG. 4 shows a template blank that is mounted on a row of teeth.

In FIG. 1 a), a template blank 1 that is designed as a small base plate and that is made of a sturdy plastic is shown. The latter has markers 2 that are applied on the top side of the small base plate as small raised structures in the form of cylinders. The markers 2 are designed as small metal structures such that they can be easily detected in the volume and surface scan and form a reference system. On the bottom side of the template blank 1, ribs 3, which are used to grip the impression material 5 better, are provided. The bottom side thus forms a receiving part for the impression material 5. In the ribs 3, holes 4—via which the template blank 1 can be clamped in a defined position in an additional treatment device—are provided.

FIG. 1 b) shows the subsequent process step, in which the bottom side of the template blank 1, provided with the ribs 3, is coated with impression material 5 that is still soft. In this state, the template blank 1 is mounted via a tooth gap on the site in the jaw 6 to be filled with the implant (FIG. 1 c). As soon as the impression material 5 is hardened, a scan of the patient is produced. In the image data, the position of the template blank 1 in comparison to the anatomy of the jaw is determined precisely.

After the scan, the template blank 1 is removed before a hole 7 is made, whose diameter and angle are planned based on the image data, and is introduced via a machine processing device (FIG. 1 d). The depth in which the drill penetrates in the operation can be determined by a stop. From the template blank 1, a ready-to-use template 8 is now produced, which can be mounted on the old position in the jaw 6 because of the hardened impression material 5. A drill sleeve 9 can be introduced into the hole 7.

In FIG. 2, an alternative embodiment of a template 10 is shown, in which in the area of the tooth gap, the template blank 1 has a reinforcement piece 11 as a drilling area. In this embodiment, a stop 12 prevents too deep a penetration of the drill sleeve 9 and stabilizes the grip thereof.

Below, the process steps are combined once again: First, the template blank is coated with an impression material by the dentist and placed in the patient's tooth gap that is to be filled. In this case, care must be taken that the adjacent teeth provide adequate hold. After a short dwell time, the impression material is hardened. The template blank, which is rigidly connected to the pressure material, can now be removed and exactly repositioned again. While the patient wears the template blank on the teeth, an image, preferably a 3D x-ray image of the jaw area, is produced. As is customary, the dentist does the planning of the drilling of holes on the computer, whereby orientation and position of the tooth or teeth to be replaced can be determined by computer simulation. Since the location of the template blank relative to the jaw can be detected automatically, the location of the holes to be drilled relative to the template blank is also known. The latter can be clamped over the defined interface in a drilling-grinding machine. The data, which are required by the drilling-grinding device for exact introduction of the holes, are supplied by the planning software. A drill sleeve, which can find its primary grip both in the template blank and in the impression material, is introduced into the hole. At the location of the missing tooth, the template blank can have a reinforcement part to reinforce the grip of the drill sleeve there. The position of the sleeve in the template blank can be regulated by a stop.

FIG. 3 shows a template blank 13 for recording two image data sets of a jaw. As a basic structure, the template blank 13 has a small base plate 14 that is made of plastic, and four markers 16 are raised from a surface 15 thereof. These markers 16 that are designed as small cylinders represent defined structures that can be produced with optical processes since they are obviously visible. In the arrangement thereof, the markers 16 form a reference system in three dimensions. They can be produced, moreover, by means of an x-ray-imaging process, which uses x-ray radiation in particular and in this case forms the same reference system. To be visible for the x-ray radiation, the markers 16 consist of a ceramic. In this case, the optically detectable markers and the markers that are visible for the x-ray radiation form the same marker structures, namely small cylinders 16 on the surface of the small base plate 14.

To provide a possibility of attaching the template blank 13 to the lower jaw 17 (FIG. 4) at a defined position on the teeth, the small base plate 14 has two ribs 18, which are buried in the first soft impression material 19, on its bottom side. Thus, on the other surface of the small base plate, a receiving part for the impression material 19 is formed. By means of the hardened impression material 19, the device can be mounted in a reproducible position both on the jaw of the patient and in the plaster model of the jaw.

In practice, the process proceeds as follows: in the preliminary area of the patient scan, the template blank 13 is coated with the quick-hardening impression material 19 and is mounted on the patient's teeth 20. In this case, it is sufficient to cover one or only a few teeth to be able to ensure a tight grip and a reproducible position. The template blank 13 thus becomes the recording template. In this case, the device is preferably mounted in an area that is not of primary interest for the medical issue. The scan of the patient is now done with the recording template that is superimposed.

For the recording of the patient data set with the physical model, e.g., in a drilling-grinding device, the recording template is attached to the model that is tightly installed in the drilling-grinding device. By means of a mechanical and/or optical coordinate measuring device, the location of the recording template is recorded. The processing steps can now be performed relative to this location. To increase the accuracy of the recording, several recording templates can also be used. For the superimposing of upper and lower jaws, in each case at least one small plate must be used.

The process for recording a volume data set that represents a jaw area of a patient can thus proceed according to the following steps with the template blank according to the invention: First, the template blank is mounted on at least one tooth of the patient in a reproducible position by means of a quickly hardening impression material, then a first image data set is recorded by means of the x-ray-imaging process, before the template blank is removed from the patient and mounted on a corresponding site on a model of the patient's jaw area. Then, with an optical imaging process, a second image data set from the surface of the model is recorded before two image data sets are superimposed (“recorded”) by means of the positions of the markers that are detected therein in each case.

1. Process for defining a common reference system between, on the one hand, a set of image data, which show the jaw (6) of a patient and which are recorded with an imaging process, and, on the other hand, a treatment template, which is attached in a removable manner during an operational intervention to the teeth of the patient in a defined position and which has a structure (7) that is used to guide an instrument, whereby markers (2) are provided on the treatment template that can be detected by means of the imaging process and that form a reference system, characterized in that a template blank (1) that is equipped with markers (2) is mounted by means of a hardening impression material (5) on at least one tooth and/or the jaw (6) of the patient at the site to be treated,
in that the set of image data with the template blank (1) that is used is recorded,
in that the template blank (1) together with the hardened and in particular break-proof impression material (5) is removed and is clamped in a processing device, and
in that the structure (7) that is necessary for guiding is introduced by tools of the processing device into the template blank (1), whereby the tools are moved according to a plan carried out on the image data.

2. Process according to claim 1, wherein the template blank (1) is placed over a tooth gap, whereby it is held on the adjacent teeth, and whereby the template blank (1) is matched to the anatomy of the respective jaw area.

3. Process according to claim 1, wherein a hole (7) is made in the template blank (1) as a guiding structure, which in position, diameter and orientation forms the guide for a drill to be used during the operation, whereby in particular a drill sleeve (9) is used in the hole (7) for stabilization.

4. Template blank (2) for a treatment template in particular for implementing the process according to claim 1, having
a first type of marker (16), which can be detected by means of an x-ray-imaging process and which forms a reference system, and
a second type of marker (16), which is formed by a defined visible structure and which also forms a reference system.

5. Template blank according to claim 4, wherein the markers of the first type and the optically detectable markers of the second type are formed from the same marker structures (16).

6. Template blank according to claim 4, characterized by a receiving part that is suitable for the coating with impression material (19) that is molded onto a stable small base plate (14) that forms the template blank (13) and that is made in particular of plastic, and its thickness allows the execution of the hole that is used as a guide.

7. Template blank according to claim 6, wherein at least three markers (16) rise as defined structures from the small base plates (14).

8. Template blank according to claim 4, characterized by means that allow a defined clamping in an additional treatment device.

9. Template blank (2) according to claim 4, wherein the small base plate (2) has a drilling area (11) with increased thickness that makes possible a deep drilling (7) and thus a good guiding.

10. Use of the template blank according to claim 4 for defining a common reference system in two sets of image data, which show the jaw (5, 17) of a patient, whereby the template blank (1, 13) is fastened in a removable manner by means of a quickly hardening impression material (5, 19) to at least one tooth of the patient in a defined position, and a first image data set is recorded by means of an x-ray-imaging process, whereby markers (4) that are found on the template blank (1, 13) form a reference system and are detected by means of the imaging process, wherein a second set of image data from the surface of a model of the jaw is recorded with an optical imaging process, in particular by means of a laser scanner, whereby the template blank that is provided with hardened impression material is mounted on the model and whereby two image data sets are superimposed by means of the positions of the markers (4, 16) that can be detected therein in each case.
